(19) United States
(12) Patent Application Publication
(10) Pub. No.: US 2018/0070541 A1
(43) Pub. Date: Mar. 15, 2018

(54) Tree shear head assembly

(71) Applicant: Robert Lachance, Saint Georges de Bauce, QC (CA)

(72) Inventor: Robert Lachance, Saint Georges de Bauce, CA (US)

(21) Appl. No.: 15/731,941

(22) Filed: Aug. 28, 2017

(30) Foreign Application Priority Data
Sep. 14, 2016 (CA) 2941877

(51) Int. Cl. A01G 23/089; A01G 23/091; B27B 11/12

(52) U.S. Cl. CPC A01G 23/089; B27G 19/00; B27B 11/12; A01G 23/091

(57) ABSTRACT

A tree shear head assembly is comprised of a connecting frame which provides connecting sections, one of which is angulated at a specific angle to connect to a boom of a motorized vehicle. The connecting frame has a shear structure secured to a lower connecting wall thereof and additional connecting sections for attachment of at least one of a clamping grapple and a tree trunk support fork secured to a support column. The shear structure has a blade which co-acts with a channel formed between gripping plates to immovably arrest a tree trunk being cut by the blade with a slicing action to prevent shattering of the trunk and damage to the tree fibers thereby achieving a clean cut. Different combinations of the shear head assembly with the clamping grapple and/or the tree support fork are easily adapted in combination with the tree shear head assembly.

### TECHNICAL FIELD

The present invention relates to tree shears and more particularly to a tree shear head assembly comprised of a connecting frame for selective connection of independent components of the tree shear head and adaptation to booms of small motorized vehicles such as, but not limited to, a mini-excavator motorized vehicle.

### BACKGROUND INFORMATION

Various types of tree shears are known in the art for cutting trees or bush clearing. Such shears use circular saw blades, chainsaws, opposed piston actuated blades, or the like to cut through a tree stump or trunk. Some problems encountered with such trunk severing is that many of these devices do not make a clean cut across the trunk resulting in splitting and shattering of the trunk at the cut end or damage to the fibers of the tree. If the fibers at the cut ends of the tree trunk logs are damaged, many sawmills will not accept such logs resulting in financial losses to the logging industry.

Another disadvantage of known tree shears is their construction which is expensive, costly to repair and also resulting in time lost due to the machine being idle during repairs. Further, industrial tree shears are not versatile to perform different tasks and therefore different machinery is required at job sites to cut, haul, pile and load logs onto transport vehicles to ship to sawmills. Known tree shears are usually constructed for specific motorized logging vehicles to perform a specific task and need extensive modification to adapt to different makes of motorized vehicles of their hydraulic systems.

There is a need to provide a tree shear head assembly that can be easily adapted to mini-excavators and be light weight and capable of transport in a pick-up truck. The shear head assembly should cut trees of from 4 to 16 inches in diameter and wherein the hydraulics of the mini-excavator do not need to be retro-fitted. The shear head assembly should be easy to construct, service and adaptable in size and accessories to suit the need of the user. It should also be manufactured in different sizes and at low cost and be inexpensive to operate and maintain.

### SUMMARY OF THE INVENTION

It is a feature of the present invention is to provide a tree shear head assembly which substantially overcomes the above mentioned disadvantages of the known prior art and provide the above mentioned needs.

Another feature of the present invention is to provide a tree shear head assembly comprised of removably connected parts making the assembly versatile and easy to repair.

A still further feature of the present invention is to provide a tree shear head assembly which is easy to adapt to the boom end of all sorts of small motorized land vehicles, such as, but not limited to, backhoe type mini-excavator vehicles.

A still further feature of the present invention is to provide a tree shear head assembly which can comprise of a different combination of parts, such as a tree shear head assembly combined with a clamping grapple or a tree support fork or both.

Another feature of the present invention is to provide a tree shear head assembly comprised of a shear structure having a blade cutting edge configuration which is capable of making a clean cut across a tree trunk without shattering or damage to the tree fibers.

According to the above features, from a broad aspect, the present invention provides, a tree shear head assembly which is comprised of a shear structure. A connecting frame has a boom connecting section to connect to a boom of a motorized vehicle. The attachment frame further has one or more connecting sections for attachment of at least one of a clamping grapple and a tree support fork secured to a support column. The shear structure has a stationary jaw member and an inwardly curved displaceable jaw member secured in a common plane with the stationary jaw member and defines a mouth opening there between for receiving a tree trunk there across. The stationary member has an elongated channel formed between a pair of straight parallel spaced members. Each of the spaced members has a forward gripping edge adjacent an entrance end of the elongated channel. The displaceable jaw member has a pivot connection at a rear end of the mouth opening and has a free forward end. A flat blade is secured to the curved displaceable jaw member and defines a straight blade edge extending between the pivot rear end and the free forward end. A cylinder is secured to the curved displaceable jaw member to progressively displace the straight blade edge of the blade towards and into the elongated channel from a rear to a front end of the channel to impart a slicing motion of the blade into a tree trunk extending across the mouth opening and gripped by the forward gripping edge on opposed sides of the elongated channel as the jaw member is progressively displaced to effect a clean cut across the tree trunk.

### BRIEF DESCRIPTION OF THE DRAWINGS

A preferred embodiment of the present invention will now be described with reference to the accompanying drawings in which:

FIG. 1 is a simplified side view illustration of a backhoe type motorized vehicle to the boom of which is secured the tree shear head assembly of the present invention;

FIG. 2 is a perspective view of the tree shear head assembly;

FIG. 3 is another perspective view of the tree shear head assembly;

FIG. 4A is a perspective view of the connecting frame of the tree shear head assembly;

FIG. 4B is a side cross-section view of the connecting frame;

FIG. 5A is a perspective view of the shear structure shown in an open condition;

FIG. 5B is a side view of the shear structure

FIG. 5C is a fragmented section view of the blade cutting edge showing the shape of the blade cutting edge;

FIG. 6A is a perspective view of the clamping grapple in an open condition;

FIG. 6B is a side view of the clamping grapple;

FIG. 7A is a perspective view of the tree trunk support fork;

FIG. 7B is a side view of the tree trunk support fork;

FIG. 7C is a top view showing a tree trunk engaged by the shear structure and resting on the support fork;

FIG. 7D is a side view showing the angle of the boom connecting plate on the connecting hub;

FIG. 8 is a rear perspective view showing a specific combination of the tree shear head assembly, and

FIG. 9 is another perspective view showing a different combination of the tree shear head assembly of the present invention.

### DESCRIPTION OF THE PREFERRED EMBODIMENT

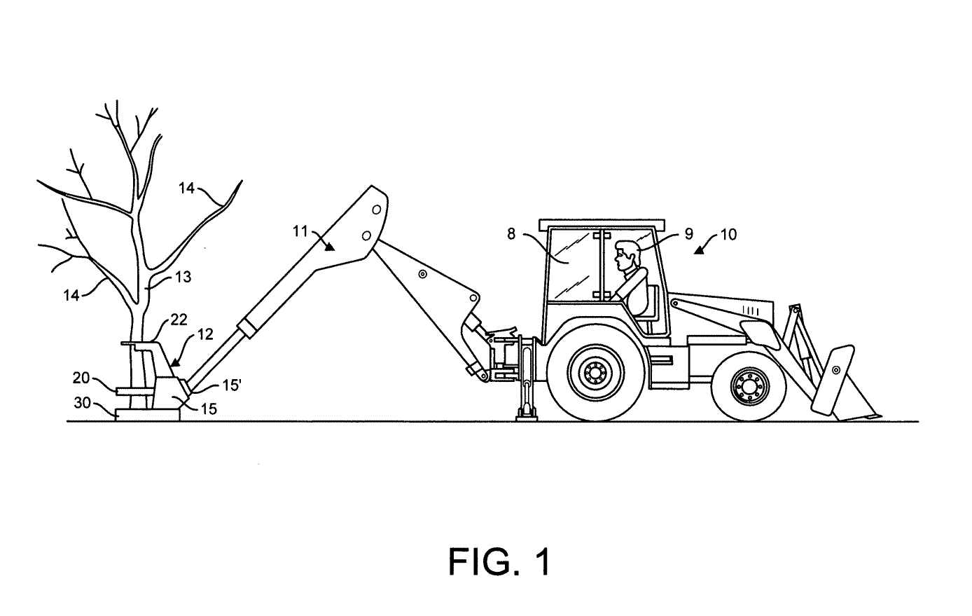

Referring to the drawings and more particularly to FIG. 1, there is shown generally at 10 a backhoe mini-excavator vehicle to the end of a boom 11 of which is attached the tree shear head assembly 12 of the present invention. As herein illustrated the tree shear head assembly is disposed about the stump of a tree trunk 13 to cut the tree. The tree shear head assembly could also be manipulated by the operator 9 of the excavator sitting in the cab 8 at the controls to cut some of the limbs 14. The mini-excavator shear head assembly can also be used to manipulated piles of cut logs to cut them to specific lengths and pile them in separated lots and load them on transport trucks.

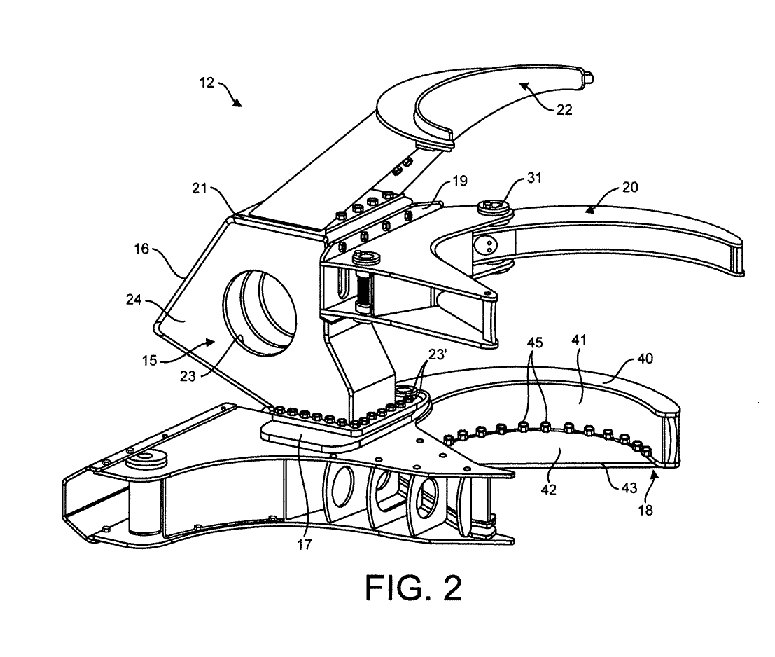

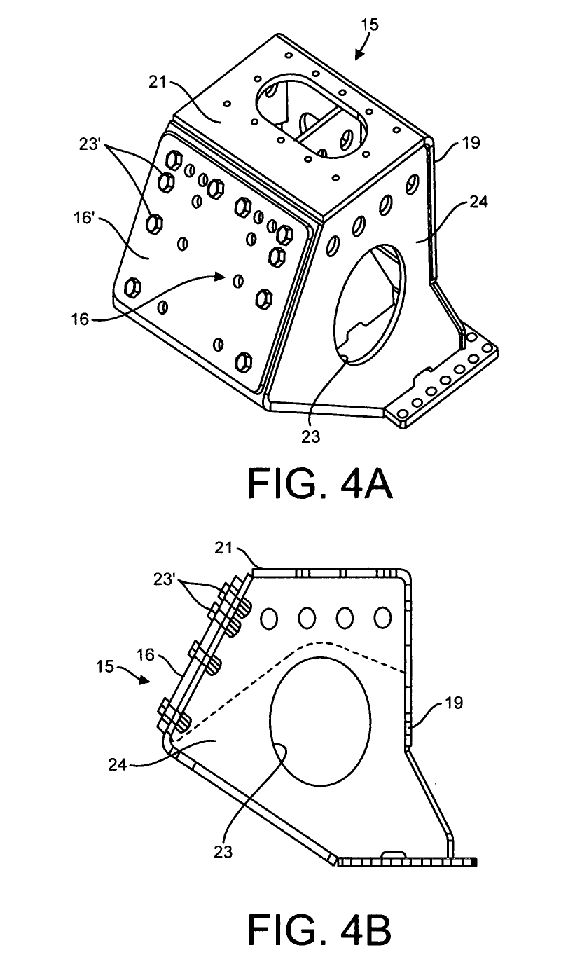

With reference now to FIGS. 2, 3, 4A and 4B, there is shown an assembled version of the tree shear head assembly 12. It is constructed of high density metal to lower its weight and is comprised of a connecting hub or frame 15 formed of connecting sections about which the tree shear head assembly components are to be connected. The connecting frame 15 defines a rear angulated boom connecting section 16, a shear structure connecting base plate section 17 for attachment to the shear structure 18, a front clamping grapple connecting section 19 for connecting to the clamping grapple 20 and a top connecting flat wall section 21 for the connection of a tree trunk support fork 22. Holes 23 are provided in the side walls 24 of the connecting frame 15 for the passage of pressure fluid conduits, not shown but obvious to a person skilled in the art, and to provide access to the connecting sections for the installation of connecting fasteners, herein bolt fasteners 23′. The boom connecting section is reinforced by a double wall, herein a plate 16′, to provide reinforcement of its connection to an attachment plate 15′ custom fitted to the free end of the boom of the mini-excavator, as shown in FIG. 1.

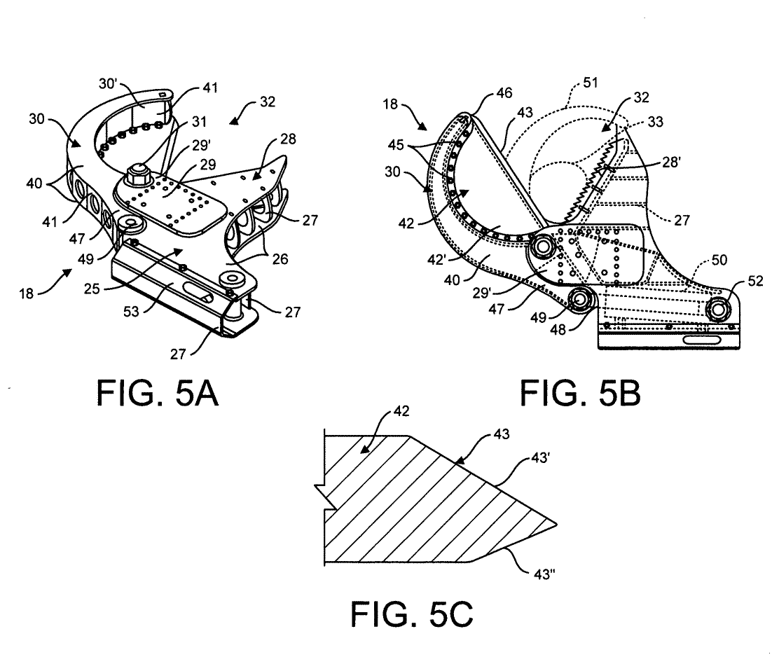

With additional reference to FIGS. 5A and 5B there is now described the construction and operation of the shear structure 18. As herein shown it is comprised of a frame 25 formed by a pair of interconnected flat steel plates 26 held spaced apart in parallel relationship by vertical spacing wall structures 27. A stationary jaw member 28 is defined by the frame 25. Connected to the frame 25 to each of the plates 26 is a hinge connecting plate 29 for the connection and support of an inwardly curved displaceable jaw member 30 secured to the hinge pin 31 secured across a projecting end portion 29′ of the hinge connecting plates 29.

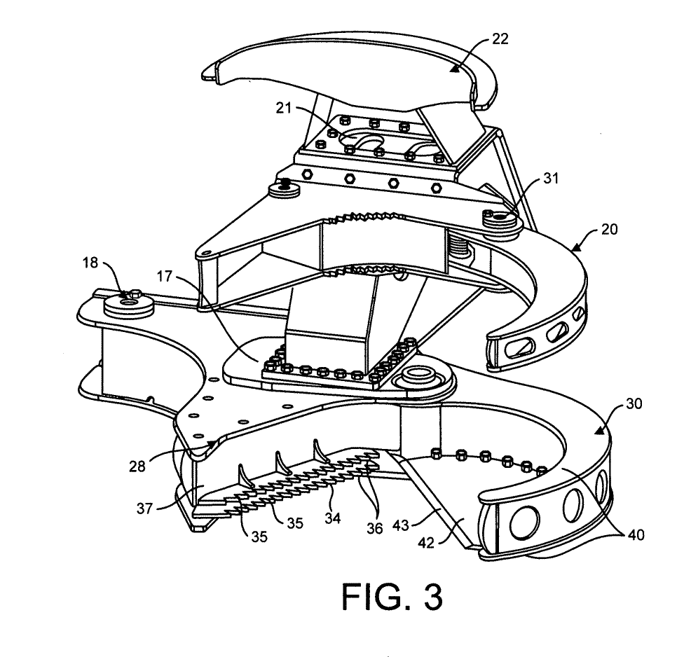

As better seen from FIG. 5B a mouth opening 32 is defined between the stationary jaw member 28 and the displaceable jaw member 30 for receiving a tree trunk 33 shown in phantom lines. As better seen from FIG. 3 the stationary jaw member 28 has an elongated channel 34 formed between a pair of straight parallel spaced plates 35 secured to a lower end of a rear wall 37 of the jaw member 28. The plates 35 are formed with a gripping toothed front edge defining saw tooth formations 36. The plates 35 project forward from the rear wall 37 of the stationary jaw member 28. The outer end of the stationary jaw member has a projecting pointed section extending forwardly inward of said mouth opening 32 to form a cage when said displaceable jaw member 30 is displaced to a closed position.

As illustrated, the displaceable jaw member 30 is also defined by a pair of curved plates 40 held in parallel relationship by vertical spacing walls 41. The curved plates are connected to the hinge pin 31 for pivotal displacement towards said stationary jaw member 28. A flat blade 42 is secured to the lower edge 44 of a bottom one of the plates 40 by removable bolt fasteners 45 for the securement and replacement of the flat blade 42. The blade has a straight blade edge 43 extending between the pivot rear end and a free forward end 46 of the inwardly curved displaceable jaw member 30. The displaceable jaw member 30 also has a rear extension arm portion 47 which is connected to a pivot rod end 48 of a cylinder 50 by a pivot connection 49. As shown by phantom lines 51 when the cylinder is pressurized the piston rod 48 extends and displaces the blade edge 43 towards the blade channel 34 of the stationary jaw member 18. The blade edge 43 is progressively displaced into the tree trunk 33 from a rear end of the blade edge to impart a slicing motion of the blade into the tree trunk 33 while pushing the tree trunk against the sawtooth formations 36 on opposed sides of the channel 34 to immobilize the tree trunk 33.

As shown in FIG. 5C, the straight blade edge 43 is a bevelled edge projecting forwardly a predetermined distance with its cutting edge having a top cutting section 43′ which extends downwards to ¾ the thickness of the blade and a short rearwards and downward section which is ¼ the blade thickness. This configuration of the cutting edge 43 produces a cut across the trunk of the tree without damage to the tree fibers and avoids shattering of the bark and fibers in the area of the cut. Also, we have found that this cutting edge configuration does not weaken the blade as compared to a cut point disposed mid-width of the blade thickness.

As shown, the displaceable jaw member 30 defines an inner vertical cage wall 30′ and the stationary jaw 28 also has an inner vertical cage wall 28′ which after the cut is made provide a surrounding wall for the bottom portion of the cut trunk to provide a surrounding cage to maintain the lower end of the cut trunk captive until the tree trunk is discharged from the tree shear head assembly by the retraction of the cylinders.

As also shown, the teeth 36′ of the saw tooth formations 36 face inwardly into the mouth opening 32 to engage the tree trunk with an inward resisting force to immovably retain the tree trunk and accordingly cause the blade to effect a clean cut across the tree trunk without shattering the trunk and damage to the tree fibers. After the cut is performed, the top series of teeth also aid in retaining the bottom of the cut trunk held in position on the top face 42′ of the blade 42 within the surrounding cage walls 30′ and 28′. The cylinder 50 is secured at a rear end on a further pivot connection 52 between the plates 26 of the stationary jaw member. It is concealed and protected by a shroud 53 forming a housing for the cylinder 50.

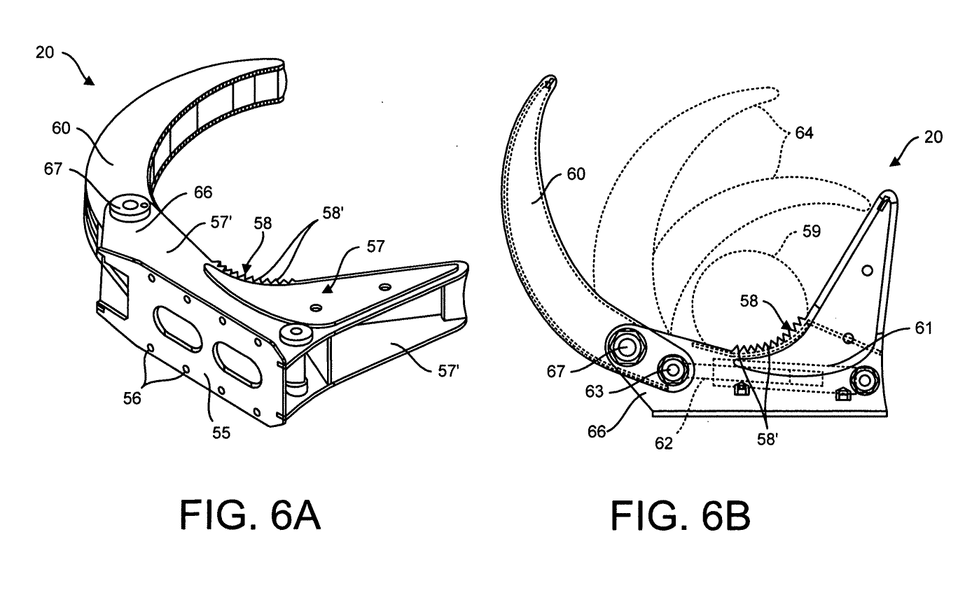

Referring now to FIGS. 6A and 6B, there is now described the construction of the gripping grapple 20. As shown, the grapple 20 has a flat connecting plate 55 with pre-drilled holes 56 for quick connection to the flat connecting wall section 19 of the connecting frame 15. The clamping grapple 20 has a stationary angulated jaw member 57 defined by a pair of parallel spaced plates 57′ defining a concavely curved toothed lower section 58 wherein there is formed a series of teeth 58 to engage a trunk 59 shown in phantom lines when grasped there against by the displaceable inwardly curved arm 60 as shown by phantom lines 64. The arm 60 is constructed in a similar manner as the arm 30 of the shear structure 18 and is actuated by a cylinder 61 having its piston rod 62 secured to a rear end pivot connection 63 of the curved arm 60 to displace the arm on a pivot pin 67 secured across a projection section 66 of the opposed plates 57′. Phantom lines 64 shows the curved arm 60 displaced at different positions towards the stationary arm 57 and pushing the trunk 59 against the curved toothed section 57. As previously mentioned these trunks vary in sizes and range between 4 to 16 inches in diameter.

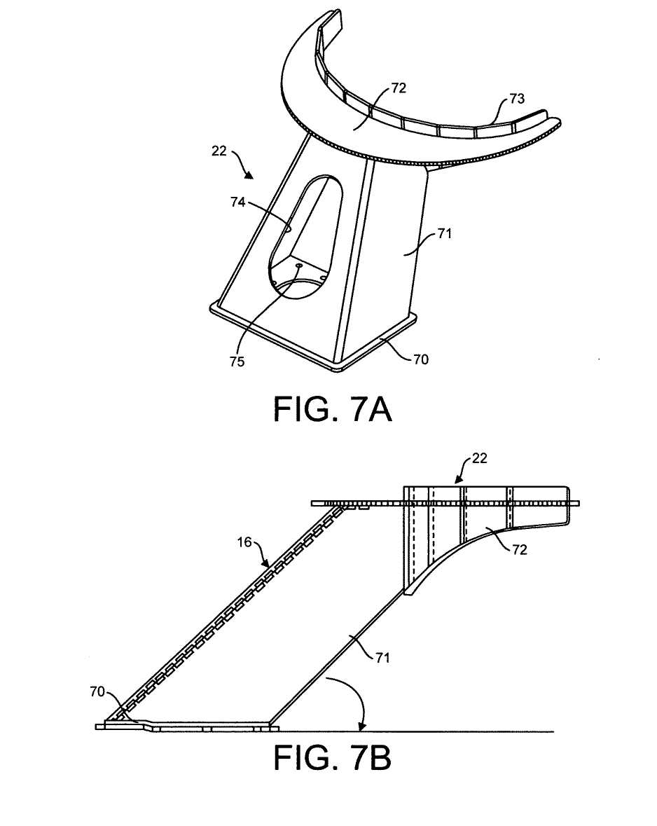

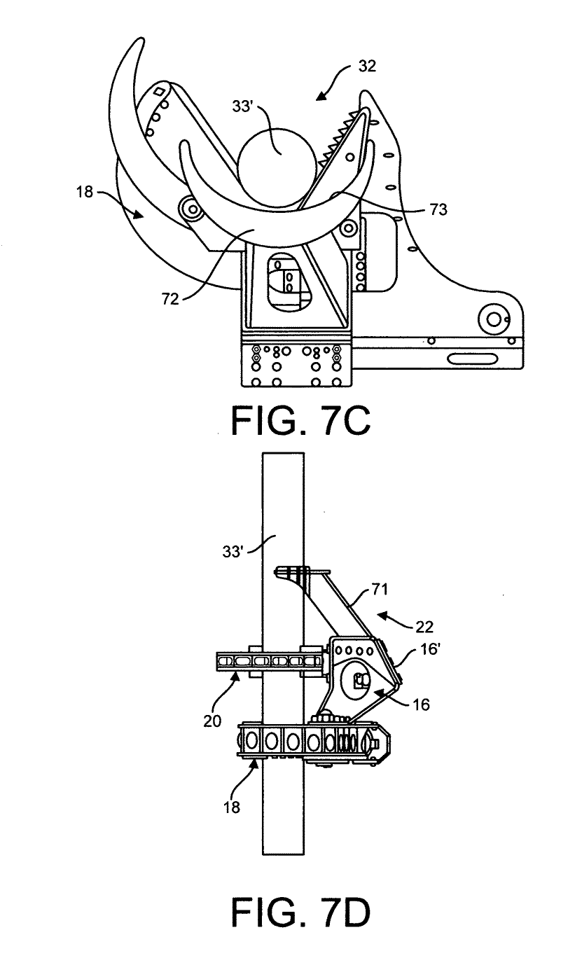

Referring now to FIGS. 7A to 7C there is shown the construction of the tree trunk support fork 22. It comprises a flat base connecting plate 70 above which extends a forwardly angulated gooseneck 71. A concave U-shaped horizontal support arm 72 is secured to a top end of the gooseneck 71 and disposed in alignment with the mouth opening 32 of the shear structure 18 for supporting a tree trunk 33′ substantially aligned with the displaceable jaw member 30 and upright as shown in FIG. 7D, for the shear to effect a clean transverse cut across the tree trunk 33′. The support arm 72 has a concavely curved front wall 73. Holes 74 are provided in the side walls of the gooseneck 71 for access to the attachment bolt holes 75 of the base connecting late 70 for securing the tree trunk support fork 22 to the top connecting wall 21 of the connecting frame 15. It is important to note from FIG. 7D that the reinforced wall 16′ of the boom connecting section is angulated at 34 degrees from the vertical axis defined by the alignment of the support arm 72 with the shear assembly mouth opening to provide safe support of the tree trunk after it has been cut. Said otherwise, the angle of 34 degrees is calculated from an axis defined by a long axis of the tree trunk 33′ supported aligned by the support arm 72 of the trunk support fork 22 and the mouth opening 32 of the shear structure 30. After the cut is performed, the tree trunk will bend very slightly rearwards to provide sage support thereof when a grapple is not used.

It is pointed out that the boom connecting section 16 or the rear wall 16′ of the or flat rear wall of the connecting frame 15 is angulated upwardly inwards towards the mouth opening 32 of the shear structure at an angle of about degrees from its support base plate or a common plane of the stationary jaw member 28 and the displaceable jaw member 30 of the shear structure. This angle ensures the proper tilt of the tree trunk when engaged by the tree shear head assembly for safe handling thereof.

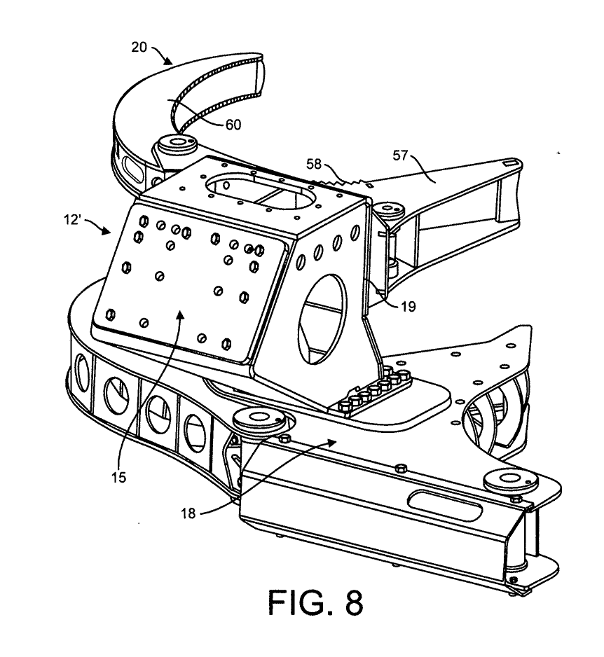

As shown in FIG. 8 the tree shear head assembly 12′ is herein shown as comprised of the combination of the shear structure 18 secured to the connecting frame 15 and the clamping grapple 20 connected to the connecting section 19 of the connecting frame 15. This combination is sufficient for the intended use of the mini-excavator vehicle to which it is intended to be connected to, such as for bush clearing or log lengths cutting.

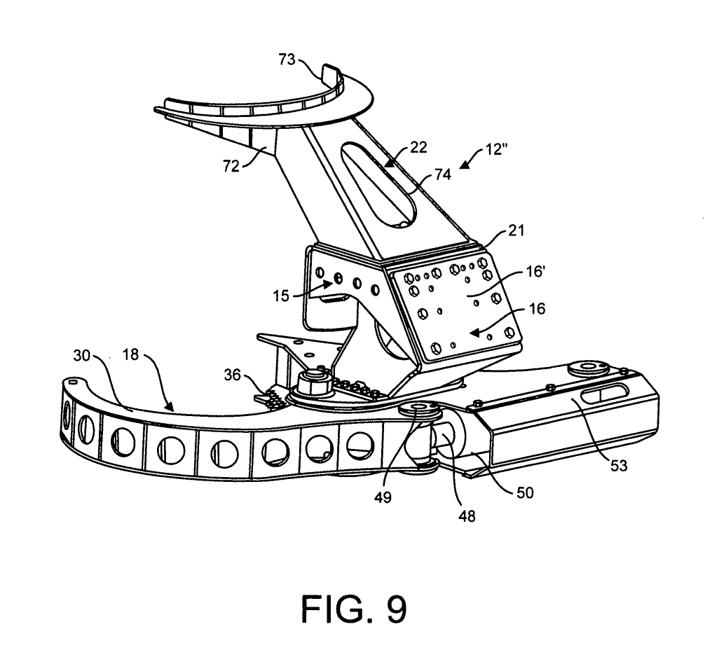

FIG. 9 shows the tree shear head assembly 12″ as comprised of the combination of the shear structure 18 secured to the connecting frame 15 and the tree trunk support fork 22 secured to the top connecting wall 21 of the connecting frame 15. The clamping grapple 20 is not provided wherein the lower end of the cut trunk is supported solely in the cage formed by the inner walls 30′ and 28′ of the shear structure.

Although not illustrated, the grapple cylinder 61 and the shear assembly cylinder 50 are operated in sequence by a direct action sequencing valve of a type manufactured the Sun Hydraulics Corporation. The grapple cylinder 61 is first actuated to extend its piston rod 62 to grasp the tree trunk before the shear cylinder 50 is actuated to cut the trunk while the trunk is held by the grapple. Sequentially, piston rod 62 is retracted before the grapple cylinder 61 is again actuated to retract its piston rod and open the grapple arm 60 to release the tree trunk. The operation of the hydraulic pistons is controlled by the operator person 9 in the cab 8 of the mini-excavator as illustrated in FIG. 1. The use of the sequencing valve does not require any special retro-fit attachments to the output pressure of the mini-excavator hydraulic system.

The tree shear head assembly 12 of the present invention was developed to meet the need of mini-excavator proprietor's who are not contractors, to replace the use of chainsaws and other tree cutting devices while being affordable. It is easily adaptable to most mini-excavator designs and is light weight capable of being transported in a pick-up truck.

It is within the ambit of the present invention to cover obvious modifications of the preferred embodiment described herein provided such modifications fall within the scope of the appended claims.

1. A tree shear head assembly comprising a shear structure, a connecting frame having a boom connecting section to connect to a boom of a motorized vehicle, said connecting frame further having one or more connecting sections for attachment of at least one of a clamping grapple and a tree trunk support fork secured to a support column, said shear structure having a stationary jaw member and an inwardly curved displaceable jaw member secured in a common plane with said stationary jaw member and defining a mouth opening there between for receiving a tree trunk there across, said stationary jaw member having an elongated channel formed between a pair of straight parallel spaced members, each said spaced members having a forward gripping edge adjacent an entrance end of said elongated channel, said curved displaceable jaw member having a pivot connection at a rear end of said mouth opening and a free forward end, a flat blade secured to said curved displaceable jaw member and defining a straight blade edge extending between said pivot rear end and said free forward end, a cylinder secured to said curved displaceable jaw member to progressively displace said straight blade edge of said blade towards and into said elongated channel from a rear to a front end of said channel to impart a slicing motion of said blade into a tree trunk extending across said mouth opening and gripped by said forward gripping edge on opposed sides of said elongated channel as said jaw member is progressively displaced to effect a clean cut across said tree trunk.

2. The tree shear head assembly as claimed in claim 1 wherein said boom connecting section is a flat angulated wall section, said boom connecting section being adapted to secure fastening means thereto for securement to said boom of a motorized vehicle.

3. The tree shear head assembly as claimed in claim 1 wherein said forward gripping edge of said spaced members is constituted by saw tooth formations having pointed teeth ends thereof facing inwardly of said mouth opening to grip to a tree trunk extending across said mouth opening when pressed there against by said straight blade edge of said displaceable jaw member.

4. The tree shear head assembly as claimed in claim 3 wherein said forward gripping edge of each said spaced members is constituted by elongated straight steel flanges secured to a bottom portion of said stationary jaw ember.

5. The tree shear head assembly as claimed in claim 3 wherein said flat blade is formed by a flat steel plate having a curved attachment section extending behind said straight blade edge, said curved attachment section having connection means for removable connection to said curved displaceable jaw member.

6. The tree shear head assembly as claimed in claim 1 wherein said curved displaceable jaw member has a rear extension section for connection to a piston end of said cylinder.

7. The tree shear head assembly as claimed in claim 6 wherein said shear structure is secured to a bottom connecting section of said connecting frame, said cylinder being secured to a rear extension portion of said shear structure.

8. The tree shear head assembly as claimed in claim 1 wherein said clamping grapple has a flat connecting plate for attachment to a flat connecting section of said connecting frame to dispose same above and in vertical alignment with said shear structure, said clamping grapple having a stationary angulated jaw member having a concavely curved toothed lower section, and an inwardly curved displaceable arm having a lower pivot connection secured spaced forwardly of said curved toothed lower section, and an actuating cylinder secured to a free lower end of said inwardly curved displaceable arm to displace said inwardly curved displaceable arm towards said stationary angulated jaw member to grasp a tree trunk extending between said stationary angulated jaw member and said inwardly curved displaceable arm at a location spaced above said shear structure.

9. The tree shear head assembly as claimed in claim 8 wherein said lower pivot connection is disposed at a predetermined distance in a projecting lower end of said stationary angulated jaw member wherein as said inwardly curved displaceable arm is displaced towards said stationary angulated jaw member said tree trunk is forced against said concavely curved toothed lower section to prevent axial rotation of said tree trunk.

10. The tree shear head assembly as claimed in claim 1 wherein said tree support fork is defined by a forwardly angulated gooseneck secured to a lower connecting plate adapted to secure a top connecting section of said connecting frame, and a concave U-shaped support arm secured to a top end of said angulated gooseneck and disposed in alignment with said mouth opening of said shear structure for supporting said tree trunk substantially aligned with said pivot connection of said displaceable jaw member of said mouth opening.

11. The tree shear head assembly as claimed in claim 2 wherein said flat angulated wall section extends upwardly inwards towards said mouth opening of said shear structure at an angle of about 34 degrees from an axis defined by a long axis of a tree trunk supported aligned by a support arm of said trunk support fork and said mouth opening of said shear structure.

12. The tree shear head assembly as claimed in claim 1 wherein said tree shear head assembly is comprised of the combination of said shear structure, said clamping grapple and said tree support fork.

13. The tree shear head assembly as claimed in claim 1 wherein said tree shear head assembly is comprised of the combination of said shear structure and said clamping grapple.

14. The tree shear head assembly as claimed in claim 1 wherein said tree shear head assembly is comprised of the combination of said shear structure and said tree support fork.

15. The tree shear head assembly as claimed in claim 1 wherein all of said connecting sections of said connecting frame are flat connecting sections adapted to receive bolt fasteners for the securement of said boom, said shear structure, said clamping grapple and said tree support fork.

16. The tree shear head assembly as claimed in claim 1 wherein said cylinder secured to said curved displaceable jaw member of said shear structure and an actuating cylinder of said clamping grapple are fluid operated cylinders, and a sequencing valve secured to an actuating pressurized line for automatic sequential operation of said cylinders through fluid line connections with said clamping grapple being firstly fully actuated before said displaceable jaw member of said shear structure.

17. The tree shear head assembly as claimed in claim 1 wherein said stationary jaw member and said inwardly curved displaceable jaw member have inner vertical cage walls wherein when said displaceable jaw member is fully displaced to cut a trunk of a tree, said inner vertical cage walls define there between a cage extending about and above said flat blade and about a lower cut end of said trunk resting on said blade.

18. The tree shear head assembly as claimed in claim 1 wherein said motorized vehicle is a mini-excavator vehicle.

19. The tree shear head assembly as claimed in claim 1 wherein said connecting frame is of substantially rectangular cross section and defines opposed side walls, and openings formed in said opposed side walls for access to connecting sections of said connecting frame for the securement of the clamping grapple, said tree trunk support fork and said shear structure.

20. The tree shear head assembly as claimed in claim 1 wherein said assembly is constructed of high density metal parts to provide for a light weight assembly.
